(19) United States
(12) Patent Application Publication
(10) Pub. No.: US 2014/0324695 A1
(43) Pub. Date: Oct. 30, 2014

(54) PAYMENT SYSTEM

(71) Applicant: ADIIES APS, COPENHAGEN O (DK)

(72) Inventor: Nels Nielsen, Copenhagen O (DK)

(21) Appl. No.: 13/870,812

(22) Filed: Apr. 25, 2013

(51) Int. Cl. G06Q 20/40

(52) U.S. Cl. CPC G06Q 20/40
USPC 705/44

(57) ABSTRACT

The present disclosure relates to a system facilitating payment for goods or services, a method for providing an authorization signal, a method for payment and a vending machine. The present disclosure presents several views on how best to achieve

### BACKGROUND OF THE INVENTION

1. Field of the Invention

The present description relates to a system for conducting payment. Further, the present description relates to a system for conducting payment using a software implemented method. Still further, the present description relates to a method for payment of services and/or products.

2. Description of the Related Art

Presently users of webpages are swamped with advertisements and mostly ignore them. This is a problem for website owners that are trying to balance a costly website development and maintenance against revenue based on number of users. One way of financing a website is banner ads which use different kinds of graphics to attract user attention. The user is then encouraged to click on the banner and the site owner may then be remunerated based on the click-through rate.

The growing popularity of smartphones, i.e. mobile telephones having a large touch sensitive display, allow software developers to generate applications for these smartphone. The banner ads are not well suited for this media and owing to the relative small size of the display graphical ads in the applications provide an unsatisfactory impression to the user. Displaying advertisements to the user before the user gains access to the application is also not effective in encouraging the user to click on the advertisement and thereby providing revenue to the developer.

The developers of the website and application may of cause require the user to pay an amount to gain access. But most users will find it annoying to have to find his or her credit card or initiate other kind of payment for small amounts, e.g. less than one Euro, for access to a website or application.

Hence, an improved system for payment would be advantageous, and in particular a more efficient method for conducting payment would be advantageous.

It is a further object of the present invention to provide an alternative to the prior art.

In particular, it may be seen as an object of the present invention to provide a system that solves the above mentioned problems of the prior art with payment for services, information and/or products.

### SUMMARY OF THE INVENTION

Thus, the above described object and several other objects are intended to be obtained in a first aspect of the invention by providing a payment system comprising an item provider, an action file provider, a server in communication with the item provider and the action file provider, the server further including a communication device for communicating with a user device having a user interface and input device, the server being configured to provide an action file in response to a request from the user device, the user device being configured to receive the action file from the server, the user device being further configured to present the action file via the user interface, the user device being configured to receive input from the user via the input device in response to the action file, the user device being configured to transmit a response based on the input from the user to the server, and the item provider being configured to provide an item in response to input from the server based on the input from the user received from the user device.

The item provider may provide electronic content or, as described later, physical items. The item provider may include an item provider server managing the communication between the server and the item provider.

The action file provider may provide electronic content including an action to be performed. This could, as will be discussed later, include manipulation of images, input of text, input of voice/recognition of words, a combination of one or more of these, or other actions as described elsewhere.

The server could be in communication with the different entities via a communication network such as the internet. The entities may also be included in the server, e.g. in one or more databases.

The user device may be a hand held device e.g. a smartphone, a computer, an interface unit including a screen/display and a keyboard or a touch sensitive input unit integrated e.g. in the screen. The user device may include an application for performing the actions as described, thereby providing a controlled access point to e.g. specific goods or services. Further, specific applications could be targeted specific uses, for instance a specific application, or app, may be provided for gaining paying for goods, such as coffee, at train stations, while a different app provides payment for a service, such as wireless internet access at an airport or airline. Still further a generic application may be provided where the application is configured or adapted to connect to any type of enabled device so that actions performed using the app is indication of payment for access to that enabled device.

The communication between the server, the item provider, the action file provider and the user device is electronic. The communication may be transmitted over a data network, such as the internet.

The item, in which the user is interested, may be an electronic item. The electronic item may for instance be an application for a smartphone or other electronic devices, services, access to web content, an image, a report, a book, a ring tone, a font, a music file, a movie file, a subscription to one or more of the above, a donation to an organization, access for a limited time to one or more of the above, access to wireless internet at a public location, payment of credit card fees during online payment, one-armed bandit/slot-machine, or a game for a game console. The electronic item may be downloaded to the user device, either for temporary storage or permanent storage. The temporary storage may include automatic deletion after a period of time or disablement of access after a period of time.

The item may be a physical item. The physical item may for instance be a beverage, including a soft drink or an alcoholic drink or a caffeinated or decaffeinated drink, including coffee or tea based drink, a snack, a piece or package of candy, potato or corn based chips or crisps, a candy bar, or a cake. The physical item may be dispensed from a self-service vending machine. The physical item may be supplied from a person in a store. These are merely examples.

A second aspect of the present invention relates to a method for providing an authorization signal at a first computer system, the method comprising the steps of receiving a first content at the first computer system; receiving an action file at the first computer system, the action file comprising a second content and an action to be performed, the action having an associated required reply; displaying the first content via an output interface of the first computer system; displaying the second content via the output interface of the first computer system, in the output interface the second content interferes with the visibility of a part of the first content, providing, via an input user interface of the first computer system, a reply in response to the presenting of the second content and the action comparing the provided reply with the required reply; and providing an authorization signal if the provided reply in comparison with the required reply fulfills a correspondence criterion.

The method according to the second aspect is preferably used in connection with electronic items. In such a use the first content may be a desired content such as an application or webpage that the user wishes to access. Further, the second content may be something that the user is to interact with, e.g. an input field for inputting characters. A user is able to see part of the desired content but needs to interact with the input field, being at least part of the second content, that is blocking the view and/or access to the desired first content. When the user has interacted the input is compared to the expected input. This could be an input string of characters, a voice input, a motion input or the like. A range of possible action or inputs are described in relation to the other aspects and are equally applicable in this aspect. When the input corresponds sufficiently to the expects input access may be given to the content. The degree of correspondence could be requiring that a string of characters are input 100% correctly. Other inputs could be determined with a lesser degree of compliance. An expected motion could e.g. be determining that a certain sequence of moves, e.g. up-down-left-tilt, is performed but without requiring a specific period of time for each move. Another could be tilting the device for a certain period of time.

The method could include that a reward signal presenting the authorization signal is transmitted to an item provider to signal that the item provider shall provide an item to a user providing the reply. The item could e.g. be internet access; credit as in points or dollars; physical item or any other item as discussed elsewhere in the present specification.

The method could comprise that the content comprises multimedia data to be presented via the output interface. The output interface could comprises one or more of: screen, speaker.

The method could comprise that the action file is transmitted via the internet, as discussed elsewhere in the present specification.

The method could comprise that the action file is provided to the first computer system via a connection to an item provider server accessible to the item provider.

The method could comprise that the action file is provided to the first computer system via a connection to a website server.

The method could comprise that the correspondence criterion represents that a degree of resemblance between the provided answer and the expected answer is equal to or exceeds a predefined threshold. The method could comprise that the provided reply is identical to the required reply.

The method could comprise that the required reply comprises a specific combination of one or more of: a letter; a number; a selected or deselected checkbox; a selection in a dropdown menu; audio data provided via a microphone; a touch or touch combination on a touch screen; a keyboard input; a light pen input.

A third aspect the present invention relates to a method of paying using a system comprising: an item provider, an action file provider, and a server in communication with the item provider and the action file provider, the server further including a communication device for communicating with a user device having a user interface and input device, the user device being configured to receive the action file. The method comprising the steps of: transmitting a request from the user device, transmitting from the server an action file in response to the request from the user device, receiving and presenting the action file via the user interface, receiving input from the user via the input device in response to the action file, transmitting to the server from the user device a response based on the input from the user, and based on the input from the user received from the user device transmitting an item delivery request from the server to the item provider.

The method may be computer implemented, i.e. software, and the steps performed using electronic devices, e.g. executed on one or more processors in one or more devices. The method may be performed using a system as described in relation to the first aspect and may include using any features mentioned in relation to the first aspect.

The method according to the second aspect provides a payment system where the user in a simple and reliable way is able to perform a micropayment for an electronic or physical item. This eliminates the burden for the user in locating and entering payment information to the server. Further, the method and system according to the present invention reduce the risk of fraudulent behavior as no funds are transferred from the user to the system. Thereby the user is presented with a safe, efficient way of paying for items.

Advantageously the server comprises expected input related to specific action files and the method further comprising a step of comparing the input received via the user interface with the expected input. This allows determination of whether the user has performed an action that was expected or not. The remuneration for the user may advantageously be dependent on whether he or she has performed an action that was expected by the action file provider in response to the content of the action content file. As will be discussed further the expected action could be correct input of text present in an image or video, recognition of words said by the user in response to output from the user device, e.g. text or sound or video. For example the user could be asked to read a sentence or series of words, the user device may then be adapted or configured to recognize words uttered and thereby be able to determine if the user has said the correct words. When it has been positively verified that the action performed corresponds to the action expected the user may be remunerated accordingly.

Each action or action type or category may be assigned a specific remuneration value.

The action to be performed may be part of a file or data collection transmitted to the user device. The user device may include a user interface displaying device. The user interface displaying device may be a mobile phone screen, a computer screen, a touch sensitive display or the like.

Advantageously the method may further comprise providing an acceptance signal in response to the user purchasing an item by performing one or more actions. The monetary transfer does not include the user and the risk of the user being subjected to fraud is reduced or even eliminated.

As mentioned a specific action may be given a specific remuneration value and the item that the user is interested in may represent a value beyond that. Therefore the method may include performing multiple repetitions of the steps mentioned. Thereby the user collects an amount corresponding, or exceeding, the value of the item where after the user may be given access to the item. Any spare or unused value may be saved for later use. In a further embodiment, the user may perform the mentioned actions at any point in time, and the value of the actions may be saved for later use. This could e.g. be used in connection with polls where a number of users are asked a question but the user does not have a specific interest in purchasing a specific item at that specific point in time where the poll is performed.

The invention is particularly, but not exclusively, advantageous for obtaining a payment system and method where a user is provided with a possibility of micro-payment without running the risk associated with providing his or her own bank information or other information allowing third parties to misuse this information.

This aspect of the invention is particularly, but not exclusively, advantageous in that the present invention may be accomplished by a computer program product enabling a computer system to carry out the operations of the apparatus/system of the first aspect of the invention when down- or uploaded into the computer system. Such a computer program product may be provided on any kind of computer readable medium, or through a network.

The individual aspects of the present invention may each be combined with any of the other aspects. These and other aspects of the invention will be apparent from the following description with reference to the described embodiments.

### BRIEF DESCRIPTION OF THE DRAWINGS

The system and method according to the invention will now be described in more detail with regard to the accompanying figures. The figures show one way of implementing the present invention and is not to be construed as being limiting to other possible embodiments falling within the scope of the attached claim set.

FIG. 1 is a schematic illustration of steps in a payment method according to the present invention,

FIG. 2 is a schematic system-chart representing an out-line of the operations of the computer program product according to the invention,

FIG. 3 is a schematic illustration of a user interface,

FIG. 4 is a schematic illustration of a vending machine and user device,

FIGS. 5 and 6 are schematic exemplary illustrations of user interfaces during polls,

FIG. 7 is a schematic illustration of a user interface where the user is to interact with an object in an image,

FIG. 8 is a schematic illustration of a webpage where a part of the page is blocked, and

FIG. 9 is a schematic illustration of steps of a method according to the present invention.

### DETAILED DESCRIPTION OF AN EMBODIMENT

The present invention relates to a method for electronic payment.

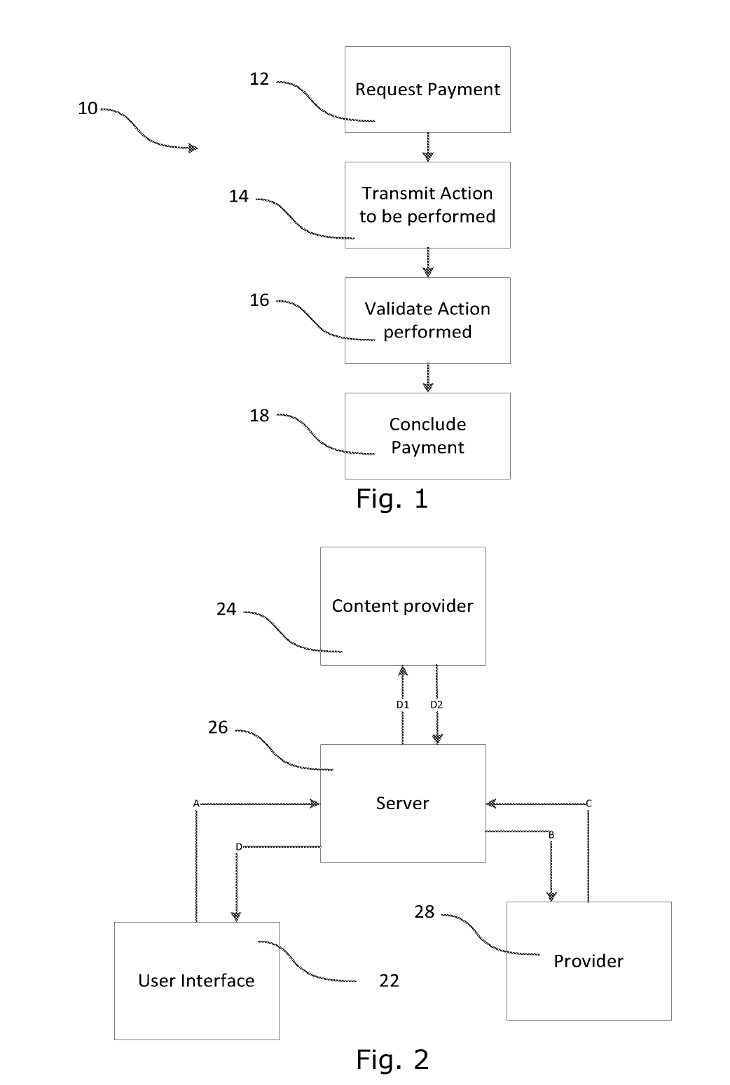

FIG. 1 schematically illustrates steps of a method according to the present invention. The method is initiated by a user wishing to access or purchase an electronic or physical item.

Electronic items include, but are not limited to, applications for smartphones or other electronic devices, services, access to web content such as articles, images, reports, books, ring tones, fonts, music files, movie files or the like, or subscriptions to one or more of the above, donations to various organizations, access for a limited time to one or more of the above, access to wireless internet at public locations, payment of credit card fees during online payment, one-armed bandit/slot-machines or the like. Also games for game consoles are example of an electronic item.

Physical items include, but are not limited to, beverages such as soft drinks, alcoholic drinks, caffeinated or decaffeinated drinks such as coffee or tea based drinks, snacks such as candy, potato or corn based chips or crisps, candy bars, cakes or the like. The user may also wish to purchase a combination of items. Further, the purchase of a more expensive item may be paid for in this way, this could include presenting a specific number of actions to be performed by the buyer, e.g. presenting 4 times a day for a period of several weeks or months depending on the cost of the product.

When purchasing small or inexpensive items the user may feel discouraged in making the purchase as he needs to locate his or her payment means, such as credit cards or the like, or initiating an electronic bank transfer. The present invention provides a method and system where such a micropayment is made easy for the user, and further, the user transfers the burden of actual payment on others. In one way it could be said that the user pays with his or her attention.

As illustrated in the method 10 of FIG. 1 the user initiates a purchase 12. The user have access via an interface device, which could be a computer, tablet device, smartphone, display with input device such as keyboard or being touch sensitive. The user is then presented with a user interface where the user is to perform an action. The action is defined in a file or data collection transmitted to the user. The action to be performed may be manipulation of an image, input of text, recognition of spoken words, a combination of a number of these, or the like.

The action to be performed is transmitted 14 to the user interface from e.g. a server. The action is then analyzed and validated with respect to an expected action. If there is a match between the performed action and the expected action, an approval is transmitted to a server.

FIG. 2 schematically illustrates parts of a system 20 according to the present invention. A user holds a device having a user interface 22. The user interface provides access to some content, provided by a content provider 24. The content could be articles, webpages, applications for computing devices such as personals computers, mobile phones, tablet computers or any other kind of computing device, music, video, or any other media files or streams.

The user using the user interface 22 wishes to access content. The computing device used by the user transmits a request, indicated by the line A in FIG. 2, to a server 26. The server processes the request. The server 26 accesses a provider database 28, indicated by the line B. The provider database 28 comprises a number of action based elements defining an action to be performed by the user in order for the user to be remunerated for performing the action. The action to be performed is returned to the server 26, as indicated by the arrow C.

The action to be performed is forwarded to the user interface 22. When the user has performed an action, the performed action is returned to the server 26 to be validated. Alternatively the validation may be performed at the user interface and an acknowledgement that the action was performed properly may be forwarded to the server 26. In either case the server 26 forwards content from the content provider 24 to the user interface.

The access to the content may be a single instance or permanent. If the content e.g. is an application a number of actions may be performed before the application is accessible on the user's device. Each action may represent a value and in order to achieve a collected amount sufficient to pay for the application the user needs to perform more than one action.

The server comprises a database holding data relating to providers of actions and data relating to providers of items to be purchased. When a user requests to purchase an item, a request is sent to the server. The server then returns an action from the database to the device that the user is using. When the appropriate action, or number of actions, is performed, the server then informs the providers of actions and the user is remunerated. This remuneration is then passed on to the provider of item or items. The user has now paid for the item or items.

This system and method provide a simple, easy to use, payment system.

The system may include a database identifying the user's interests so that an action falling within the user's interest may be selected and forwarded to the user. The user may register and indicate his or her interests, e.g. sports, food, travel etc. This information could be collected during a registration process. Registration may include communication with a social network service, such as Facebook or the like. Such a social network may also be used by the system when identifying the user while using the system and/or method as described in the present disclosure. The server may then base a choice on which action to transmit to the user on that information. Also, the server may comprise information as to which actions the user has previously been presented with. This enables a limit to the number of times a user may be presented with a specific action or actions from a specific vendor. This further enables maximizing distribution of actions to a group of users, i.e. targeting actions to a group of users having indicated a specific interest in a certain subject.

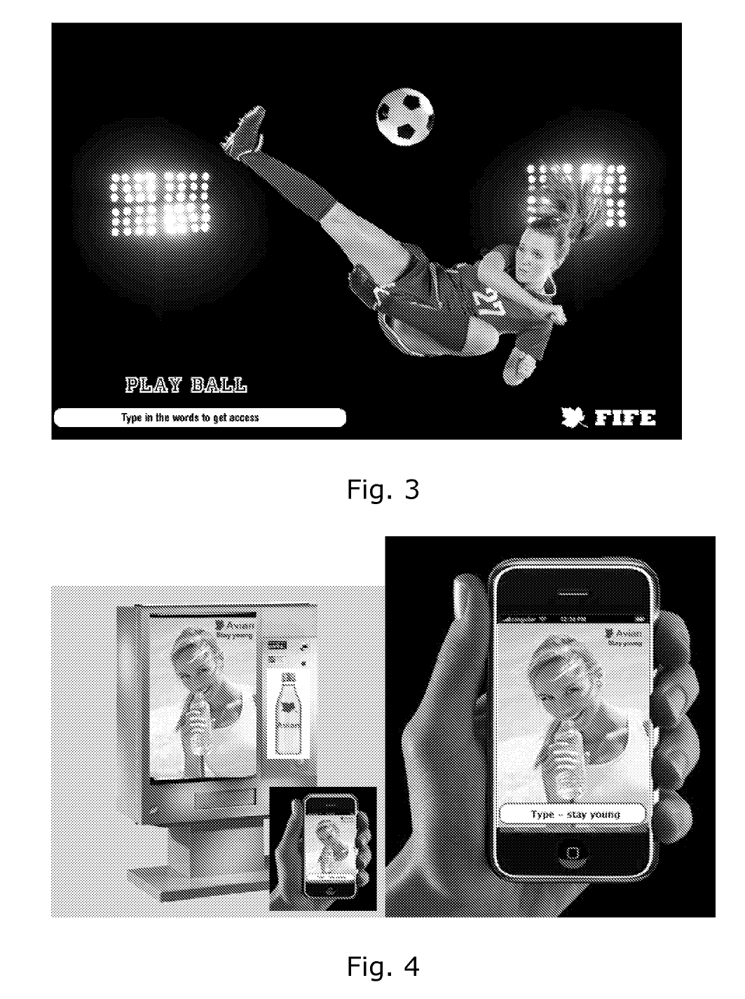

The actions may then have content within one or more of these fields or subjects. The action could e.g. be that the user is to view an image of a soccer player where a text relating to a product is included where the appropriate action then could be that the user types the text from the image. Such an example is illustrated in FIG. 3.

The user may initiate the method or system to perform one or more actions so as to save up remuneration to be used at a later point in time.

FIG. 3 is a schematic view illustrating a possible view that may be presented to a user. The user, having indicated that he or she has an interest in soccer/football, is presented with this image of a young person holding a ball. The text relates to a slogan for a given company and the user is prompted to input the text in the image. When the user inputs a text the inputted text is checked against an expected text, i.e. identical to that in the image, and if there is a match between the two texts, the user is remunerated accordingly. This remuneration is then used to allow the user to gain access to the desired content. If the level of payment for the desired content is higher than the remuneration, subsequent actions may be presented to the user until sufficient remuneration is collected.

FIG. 4 schematically illustrates a system including a vending machine in the left-hand side of the figure. The vending machine displays an image, here in the form of a commercial for water. The company behind the commercial has a name and a slogan.

A process of purchasing an item is initiated by the user. The vending machine is adapted to communicate with a portable device, such as a mobile phone, via wireless communication. The implementation of the wireless communication could be based on Near Field Communication, but other technologies could be used, such as Bluetooth, GSM or other radiofrequency or infrared based communication.

The user is presented with a user interface similar to that discussed in relation to FIG. 3. When the user has completed the action the user may have a choice of paying for the item at a reduced price or if sufficient remuneration is received, purchasing the item for that amount. Alternatively, a number of actions may be performed before the item is paid for. In this example the action is to retype the slogan from the commercial.

Further, a location based service may be provided, where an application on a user held device uses location of the device to indicate to the user where the nearest, physical, machine is, e.g. vending machine. This allows the user to easily be guided to a location for getting a cup of coffee, water or other goods. The user held device may advantageously include a GPS receiver.

Other types of products may be paid for using the method and/or system according to the present invention.

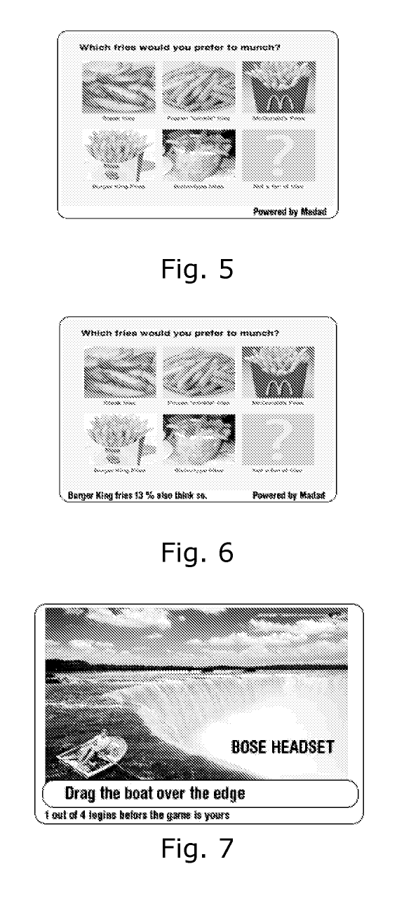

FIG. 5 schematically illustrates an embodiment where the method and system is used for a poll. The user is presented with a range of choices. The user inputs his or her choice. In FIG. 6 the user has chosen ‘Burger King’ and is presented with the fact that 13% of the users that have responded also prefer ‘Burger King fries’. Most people find this kind of information fun to know and is a further incentive for the user to answer this kind of poll. The user is remunerated in the same way as described above. Further types of polls include exit polls during periods of election. In such an embodiment there may be restrictions on display of results of the poll.

In an airport a large number of travelers have a wish to use their smartphone or laptop for internet access. The upkeep of a wireless internet access may be for using the method according to the present invention. The user in the airport uses his or her own portable device. The user has signed up and the wireless system in the airport is in contact with the server described in relation to FIG. 2. When the user connects to the wireless access at the airport, the user is guided to a site where he or she indicates how to pay for the access. The user is presented with a range of options. A period of 30 minutes access to the internet may be paid in two ways, by debit or credit card or by performing one or more actions. The actions are similar to those described above. Other time periods and further payment methods may be included, e.g. redeeming a voucher or the like representing a value for a specific period of time, such as 30 minutes, 60 minutes, 120 minutes, or a specific amount of data such as 1 MB, 5 MB, 10 MB or other amount of data.

Further embodiments include access to specific websites or domains for a limited period of time.

In an embodiment the method and/or system is used in cooperation with a camera device. The camera device is then used for recording an image containing an optical detectable code. Such an optical detectable code could be a QR code. The optical detectable code is then used to direct the user to a webpage or electronic store or to cause the user device to present an action file to the user.

FIG. 7 schematically illustrates a user interface where an image is displayed. The image comprises an object, here the boat that the user is to interact with. The image comprises a text area where it reads: ‘Drag the boat over the edge’. The user then uses an input device, such as a finger on a touch screen or a mouse or other suitable input device, The system compares the users action with the expects, e.g. by recording one or more sequences of inputs from the user corresponding to the path that the user drags the object. If the input corresponds to the expected the user is rewarded or remunerated accordingly as described herein.

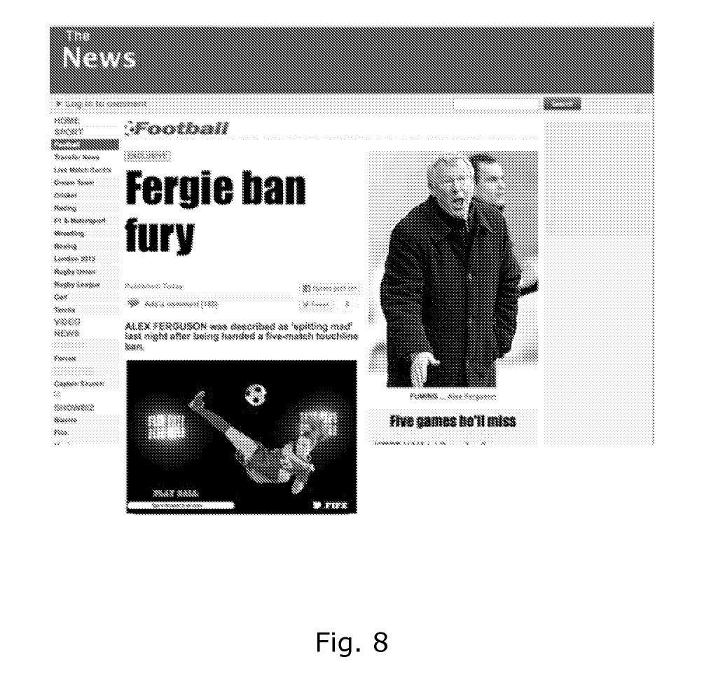

FIG. 8 illustrates a webpage where a user wishes to gain access to content, here illustrated as an article. A part of the article is blocked by an image having an input field. A method according to the present invention may be used to gain access to the article. The method provides an authorization signal at a first computer system, here the first computer system comprise a web browser. The method comprises the steps of receiving a first content at the first computer system; this is in this embodiment the webpage data. Receiving an action file at the first computer system, the action file comprising a second content and an action to be performed, the action having an associated required reply; in this embodiment this is the image and associated input field. Displaying the first content via an output interface of the first computer system; here displaying the webpage in the web browser. Displaying the second content via the output interface of the first computer system, in the output interface the second content interferes with the visibility of a part of the first content, here the image blocks part of the web page. Providing, via an input user interface of the first computer system, a reply in response to the presenting of the second content and the action, the user inputs a text string corresponding to a text in the image. Comparing the provided reply with the required reply; and providing an authorization signal if the provided reply in comparison with the required reply fulfills a correspondence criterion. The method may allow some variation in the input, for a text string this may include ignoring two or more spaces in the input string.

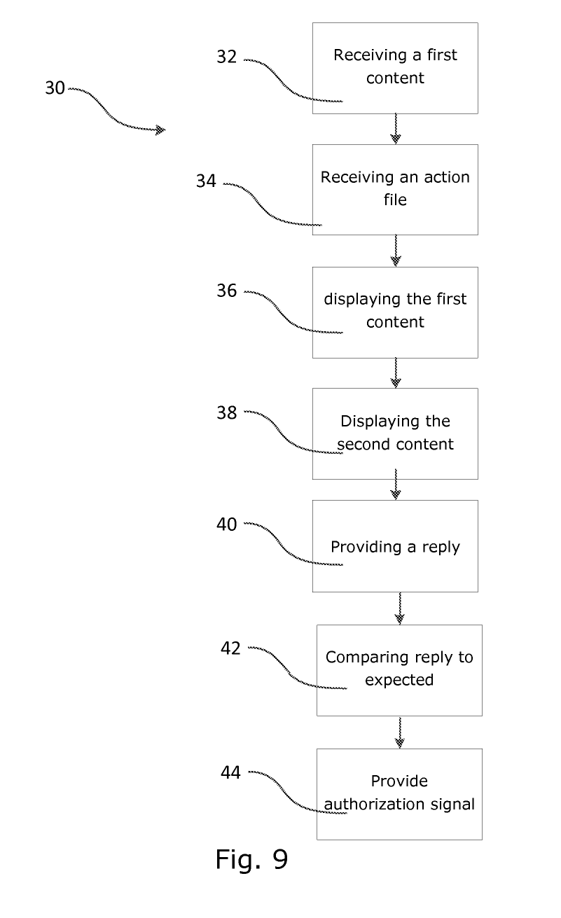

FIG. 9 schematically illustrates the steps of a method (30) for providing an authorization signal at a first computer system, the method (30) comprising the steps of receiving a first content (32) at the first computer system;
receiving an action file (34) at the first computer system, the action file comprising a second content and an action to be performed, the action having an associated required reply;
displaying the first content (36) via an output interface of the first computer system;
displaying the second content (38) via the output interface of the first computer system, in the output interface the second content interferes with the visibility of a part of the first content,
providing, via an input user interface of the first computer system, a reply (40) in response to the presenting of the second content and the action
comparing (42) the provided reply with the required reply; and
providing the authorization signal (44) if the provided reply in comparison with the required reply fulfills a correspondence criterion.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

What is claimed is:

1. A payment system comprising:
an item provider server,
an action file server for providing an action file having an associated accepted action, and
an exchanging server in communication with the item provider and the action file provider, wherein:
the exchanging server comprises a communication device for communicating with a user device having a user interface and input device,
the exchanging server is configured to provide the action file in response to a request from the user device,
the user device is configured to receive the action file from the server
the user device is configured to present the action file via the user interface,
the user device is configured to receive input from a user via the input device in response to presenting the action file,
the user device is configured to transmit to the exchanging server a response based on the received input, and
the item provider server is configured to provide an acceptance signal in response to input from the server based on the input from the user received from the user device.

2. The payment system according to claim 1, wherein the item is an electronic item.

3. The payment system according to claim 2, wherein the electronic item is an application for a smartphone or other electronic device, service, access to web content, an image, a report, a book, a ring tone, a font, a music file, a movie file, a subscription to one or more of the above, a donation to an organization, access for a limited time to one or more of the above, access to wireless internet at a public location, payment of credit card fees during online payment, a one-armed bandit/slot-machine, or a game for a game console.

4. The payment system according to claim 1, wherein the item is a physical item.

5. The payment system according to claim 4, wherein the physical item is a beverage, a soft drink, an alcoholic drink, a caffeinated drink, a decaffeinated drink, coffee, tea, a snack, a piece of candy, a package of candy, potato chips, corn based chips, crisps, a candy bar, or a cake.

6. A method for providing an authorization signal at a first computer system, the method comprising:
receiving a first content at the first computer system;
receiving an action file at the first computer system, the action file comprising a second content and an action to be performed, the action having an associated required reply;
displaying the first content via an output interface of the first computer system;
displaying the second content via the output interface of the first computer system, in the output interface, wherein the second content interferes with the visibility of a part of the first content,
providing, via an input user interface of the first computer system, a reply in response to the presenting of the second content and the action,
comparing the provided reply with the required reply; and
providing an authorization signal if the provided reply in comparison with the required reply fulfills a correspondence criterion.

7. The method according to claim 6, wherein a reward signal based on the authorization signal is transmitted to an item provider to signal that the item provider shall provide an item to a user.

8. The method according to claim 6, wherein the first content comprises multimedia data to be presented via the output interface.

9. The method according to claim 6, wherein the action file is transmitted via the internet.

10. The method according to claim 6, wherein the correspondence criterion represents a degree of resemblance between the provided answer and the expected answer being equal to or exceeding a predefined threshold.

11. A method of paying using a system comprising an item provider, an action file provider, and a server in communication with the item provider and the action file provider, the server further comprising a communication device for communicating with a user device having a user interface and input device, wherein the user device is configured to receive the action file, the method comprising:
transmitting a request from the user device,
transmitting from the server an action file in response to the request from the user device,
receiving and presenting the action file via the user interface,
receiving input from the user via the input device in response to the action file,
transmitting to the server from the user device a response based on the input from the user, and
based on the input from the user received from the user device transmitting an item delivery request from the server to the item provider.

12. The method according to claim 11, wherein the server comprises expected input related to specific action files and the method further comprises comparing the input received via the user interface with the expected input.

13. The method according to claim 11, further comprising transferring an amount of money from a provider of an action file to a provider of items.

14. The method according to claim 11, further comprising performing multiple repetitions of the steps.

15. The method according to claim 11 wherein the method is implemented as a computer program and the steps performed in a computing device.

16. A vending machine comprising a product store and a control unit electrically connected to a communication unit, the control unit operating the release of products from the product store in response to signals from the communication unit, the communication unit receiving data from a user held device, wherein the data comprises information relating to payment, the information being generated in the device in response to the user performing an accepted action.

17. The vending machine according to claim 16, wherein the accepted action is associated with an action file in the user held device.

18. The vending machine according to claim 16, wherein the vending machine and/or user held device is adapted to receive input from a user via a user device in response to an action and, based on the input from the user received from the user device, transmitting an item delivery request from a server to an item provider.
